(19) United States
(12) Patent Application Publication
(10) Pub. No.: US 2003/0184837 A1
(43) Pub. Date: Oct. 2, 2003

(54) Saturable absorbent structure, in particular for regenerating optical component and method for making same

(76) Inventors: Alexandre Marceaux, Plaisir (FR); Slimane Loualiche, Cesson Sevigne (FR); Alain Le Corre, Cesson Sevigne (FR); Olivier Dehaese, Saint Jacques De La Lande (FR)

Correspondence Address: FOLEY AND LARDNER, SUITE 500, 3000 K STREET NW, WASHINGTON, DC, 20007, US

(21) Appl. No.: 10/332,532

(22) PCT Filed: Jul. 10, 2001
(86) PCT No.: PCT/FR01/02219

(30) Foreign Application Priority Data
Jul. 11, 2000 (FR) 00/09030

(51) Int. Cl. G02F 1/01; G02B 26/00

(52) U.S. Cl. 359/238

(57) ABSTRACT

The invention concerns a saturable absorbent structure comprising a stack of layers forming a succession of quantum wells and barriers and a plurality of recombination centres distributed in said stack. The invention is characterised in that the recombination centres are made of a material such that they define with the materials of the stack one or several energy levels in the forbidden band of energy defined between the conduction band and the valence band of the wells of the stack.

### GENERAL TECHNICAL FIELD

The present invention relates to a saturable absorbent structure, especially for an optical signal regeneration component.

It also relates to a process for producing such a structure.

Advantageously, the invention is particularly applicable in fiber-optic communication networks operating at very high data rates (>2.5 Gbits/s).

Transmission via optical fiber offers many advantages, especially in terms of costs, link capacity and link quality, and in terms of flexibility conferred on the network.

In particular, the introduction of optical fiber into the inter-city network has now become a concrete reality, as has the multiplication of intercontinental submarine links.

However, very high data rate communications are still limited by certain technical difficulties (very high data rate modulators, propagation with dispersion compensation, soliton propagation, etc.). The technologies allowing very high data rates to be achieved have still to be made reliable before they can be introduced into the network.

The appearance of wavelength-multiplexed networks has made it possible to achieve a great deal of progress in the field of increasing the data rate while retaining the structures that have been installed.

Another factor which had to be controlled, in order to maintain optical transparency, is in-line optical amplification made possible by reliable erbium-doped fiber-optic amplifiers of high bandwidth and compatible with the installed network.

However, high data rate fiber-optic communication still remains limited by the signal regeneration function.

This is because the quality of the link depends greatly on the quality of the signals that propagate therein. To use the line properly requires an increase in the optical operations along the link and at the various nodes of the network. To increase network flexibility, a very large number of operations, such as monitoring, signal insertion/extraction or amplification operations, may be added. Each operation introduces degradation, little by little destroying the quality of the link.

This is why it is conventional practice to distribute optical regeneration components along the transmission line which allow the signals to be reshaped and their quality to be restored so that it approaches as far as possible the original.

Few solutions have hitherto been proposed for allowing in-line regeneration of the signal while maintaining optical transparency in terms of data rate and wavelength.

### PRESENTATION OF THE PRIOR ART

One technique currently studied by several laboratories is based on resonant nonlinearities in semiconductors and is associated with the use of saturated absorption in multiple quantum well structures. More specifically, this technique uses in particular the optical nonlinearities in the vicinity of the exciton peak in quantum wells.

Reference may be made, for example, in this regard to the following various publications:

R. Takahashi, Y. Kawamura, T. Kagawa and H. Dwamura, Appl. Phys. Lett. 65, p. 1970, 1994;

E. Lugagne Delpon, J. L. Oudar, N. Bouche, R. Raj. S. Shen, N. Stelmakh and J. M. Lourtioz, Appl. Phys. Lett. 72, p. 759, 1998;

H. Hirano, H. Kobayashi, H. Tsuda, R. Takahashi, M. Asobe, K. Suto and K. Hagimoko, Electronics Letters 34, p. 198, 1998; and

J. Mangeney, J. L. Oudar, J. C. Harmand, C. Meriadec, G. Patriarche, G. Aubin, N. Stelmakh and J. M. Lourtioz, Appl. Phys. Lett. 76, p. 1371, 2000.

The advantage of this type of component is that it is “passive”, that is to say it does not require any electrical supply, thereby increasing its simplicity and its reliability. In addition, it makes it possible to separate the “regeneration” function from the “amplification” function and to optimize these two functions separately.

To improve the quantum efficiency of this structure, the multiple quantum well active zone is placed inside a vertical cavity having integrated Bragg mirrors. Consequently, the drive powers come to be compatible with the powers delivered by semiconductor lasers.

However, an important problem remains to be solved, namely that of the temporal response. This is because the rise time of the nonlinear phenomenon is very short (<1 ps), whereas the time to return to equilibrium is relatively long (of the order of 1 ns).

Thus, the regeneration techniques that use optical nonlinearities in multiple quantum wells near the exciton peak come up against the problem of the speed of response of the optical component. Excitonic absorption is practically instantaneous and its bleaching by the excitons is very short (rise time around 1 ps), whereas the return to equilibrium is dominated by the lifetime of the carriers, which is around a few nanoseconds in the materials studied.

Improving the time to return to equilibrium is equivalent to controlling the lifetime of the carriers photocreated in the structure.

Two techniques are already known for lowering the lifetime of the carriers down to values compatible with the processing of rapid optical signals. These two techniques are:

the growth of materials containing a large quantity of defects;

the creation of a large quantity of defects by an ion implantation method.

In one example of implementation of the first of these techniques, a low-temperature (approximately 200°) growth operation is carried out followed by beryllium doping and annealing at 500° C. This operation gives rise to a material in which the carriers have a very short lifetime, given the presence of AsGa antisites and of Be—As complexes which act as recombination centers. Using this technique, times to return to equilibrium of 4 ps have been achieved.

A structure included in an optical cavity and obtained in this way has made it possible to produce an optical regenerator operating at 10 Gbits/s.

However, this technology has two major drawbacks:

it is complex to employ (low-temperature growth, Be doping up to 4×10¹⁷/cm³ and annealing at 500° C.);

it also results in there being a tendency for the exciton peak to be attenuated, this being prejudicial to the operation of the component observed experimentally after growth and beryllium doping.

The second known technique consists in using high-energy ion bombardment to create defects. The acceleration ions lose their energy by electrostatic deceleration over the major portion of the path, and by impact with the atoms of the lattice in the stop region, resulting in a large number of defects being produced in this region. This prior technique of creating defects has been used on AlInAs/GaInAs multiple quantum wells irradiated with heavy Ni⁺ ions accelerated to 12 MeV. For irradiation doses varying from 5×10¹⁰ to 10¹² per cm², the lifetimes range from 50 ps to 1.6 ps.

Using this technique, defects are obtained over the entire trajectory of the ions and these defects have levels distributed within the entire band gap of the active material. The presence of these defects considerably increases the actual absorption in the high band-gap material such as InP.

However, it should be pointed out that the absorption contrast in the vicinity of the exciton peak is highly attenuated because of this additional absorption, this contrast decreasing when the irradiation dose increases.

In addition, these irradiation defects are known to be unstable; the long-term stability of the properties of the structure remains to be demonstrated.

Finally, the treatment is very expensive as it requires the optical component to be passed from the epitaxy chamber to a heavy-ion accelerator, which is a bulky, complex and highly costly installation.

### SUMMARY OF THE INVENTION

The present invention provides a saturable multiple quantum well absorbent structure having recombination centers, which has very short times to return to equilibrium and which consequently allows optical signal regeneration in times compatible with rapid optical signal processing (>10 Gbits/s).

The proposed structure has a high absorption efficiency.

It also exhibits very good long-term stability.

More particularly, the structure proposed by the invention is a saturable absorbent structure comprising, on the one hand, a multilayer stack constituting a succession of quantum wells and of barriers and, on the other hand, a plurality of recombination centers which are distributed within said stack, characterized in that the recombination centers are made of a material such that they define, with the materials of the stack, one or more discrete energy levels in the energy band gap defined between the conduction band and the valence band of the wells of the stack.

In this regard, it should be noted that, in the case of the structures obtained with the prior techniques such as those mentioned above, the recombination centers have energy levels distributed throughout the band gap of the multiple quantum well structure, which results in the appearance of parasitic absorptions.

As regards the proposed structure—in which the recombination energy level or levels are discrete—this prevents these parasitic absorptions.

However, the structures in which there is only a single recombination energy level in the band gap, this energy level being discrete, are preferred insofar as these structures exhibit a higher absorption efficiency.

Moreover, the recombination centers are advantageously chosen to be made of a material such that a discrete recombination energy level is located substantially in the middle of the bend gap, that is to say at the point where the efficiency of carrier trapping is optimal, such recombination centers then acting effectively on both types of photocreated carriers—electrons and holes.

In particular, it is advantageous for the layers of the stack to be made of III-V materials, while the recombination centers are iron atoms; there is then only a single discrete recombination energy level centered on the middle of the band gap.

For example, the stack may comprise an In_{0.53}Ga_{0.47}As/InP succession.

However, other materials for the layers of the stack and the recombination centers are conceivable.

Moreover, the invention provides a process for producing such a structure, which is of much greater simplicity than the abovementioned production processes.

According to this process, the layers of the stack are grown by epitaxy and the recombination centers are introduced by doping during the epitaxial growth of said layers of the stack.

As will have been understood, with such a process the recombination centers are introduced into the structure during growth of the latter, in a single technical operation.

Furthermore, such a process has the advantage of allowing the spatial location and the concentration of the doping to be accurately controlled.

The invention furthermore relates to an optical component, and especially to an optical signal regeneration component, which has a saturable absorbent structure of the aforementioned type.

It also relates to a fiber-optic transmission system comprising a transmission line and means for emitting and for receiving an optical signal transmitted by said line, characterized in that it includes, in the transmission line, at least one regeneration component of the aforementioned type.

### PRESENTATION OF THE FIGURES

Further features and advantages of the invention will become more apparent from the following description, which is purely illustrative and nonlimiting and which should be read in conjunction with the appended drawings in which:

FIG. 1 is a graph in which the normalized transmission rate curves have been plotted as a function of the rate of return to equilibrium in the case of a doped structure in accordance with one possible embodiment of the invention and in the case of an undoped structure;

FIG. 2 is a graph in which the variations in contrast have been plotted as a function of the density of the pump carriers in the case of a doped structure in accordance with one possible embodiment of the invention and in the case of an undoped structure;

FIG. 3 is a graph in which the time to return to equilibrium has been plotted as a function of the dopant concentration; and

FIG. 4 is a graph in which the variations in contrast have been plotted as a function of the density of the carriers generated by the pump for various doping concentration values.

### DESCRIPTION OF ONE OR MORE EMBODIMENT AND IMPLEMENTATION EXAMPLES

One example of a saturable absorbent structure according to one possible embodiment of the invention is a structure comprising a stack of 50 In_{0.53}Ga_{0.47}As/InP multiple quantum wells, the excitonic absorption peak of which is located at approximately 1.57 μm.

As an example, the InGaAs layers are of 8 nm, while the InP layers are of 10 nm.

An iron (Fe) doping—which defines recombination centers in the structure—is introduced into the various layers of this stack during epitaxial growth of the latter.

It should be noted that the fact of introducing the recombination centers by doping during growth makes it possible for the spatial location of these trapping centers to be accurately controlled and to be positioned only in the necessary regions to the exclusion of any other region.

Furthermore, the concentration of trapping centers is controlled and can be adjusted in order to obtain the carrier lifetime value strictly necessary for the intended component.

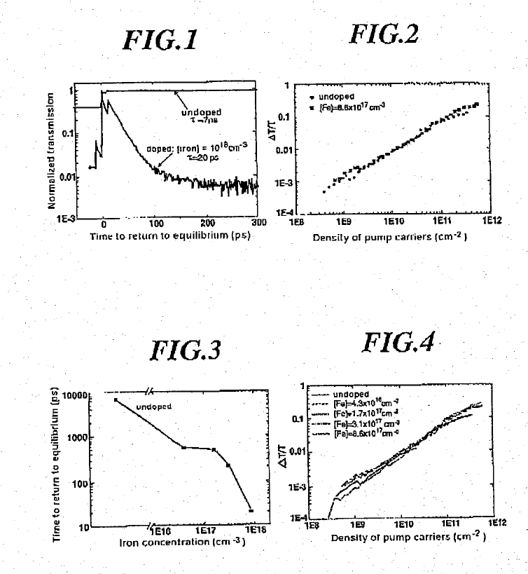

The influence of the iron doping on the return-to-equilibrium properties of the absorption saturation in a structure of the aforementioned type was studied. The results obtained by the inventors are given in FIGS. 1 to 4.

FIG. 1 shows measurements of the time to return to equilibrium taken on two specimens using a pump-probe experiment.

The first one is the control specimen—it is not doped with iron. It may be seen that the time to return to equilibrium of the absorption saturation is approximately 7 ns.

The second specimen is highly doped—it has an iron concentration of approximately 10¹⁸/cm³. Its return-to-equilibrium time constant drops to 20 ps.

FIG. 2 shows the variation in transmission contrast as a function of the number of carriers photocreated in the same two specimens. The number of carriers created is directly proportional to the light intensity in the structure. The transmission contrast ΔT/T is the ratio of the transmission difference ΔT, between the optical transmission coefficient of the structure subjected to a high intensity and the optical transmission coefficient of the structure at low light intensity, to T, the measured transmission coefficient.

It may be seen that, in the case of the highly doped specimen, the transmission contrast remains equal to that of the control specimen. The process therefore allows the time to return to equilibrium of the structure to be reduced, while maintaining the properties thereof.

Three further iron-doped specimens were studied and compared with the non-iron-doped control.

These specimens were doped while they were being grown according to the process of the invention. Their concentration was estimated by a Hall technique allowing the number of free carriers to be measured. This total number of carriers in the structure corresponds to the difference between the dopant concentration and the concentration of the trapping centers represented here by iron. The iron concentration values obtained by this means vary from 10¹⁶/cm³ in the case of the specimen doped least to 10¹⁸/cm³ for that doped most.

FIG. 3 shows measurements of the time to return to equilibrium taken on these specimens using a pump-probe. Examination of the curve demonstrates the effect of the iron doping on the time to return to equilibrium. The value of this time varies from 7 ns in the case of the control specimen to 20 ps in the case of the most doped specimen. Controlling the iron concentration makes it possible to control the time to return to equilibrium of the structure.

FIG. 4 shows the variation in transmission contrast as a function of the number of carriers photocreated in these same specimens. To demonstrate the influence of the iron doping on this transmission contrast, the curves obtained for the various dopant concentrations have been shown on the same graph. It may be seen that the contrast remains independent of the concentration, this being so for all the light intensity values explored. The proposed process therefore makes it possible to control the time to return to equilibrium of the structure, while maintaining the efficiency thereof, as proved by the various optical transmission contrast measurements.

1. A saturable absorbent structure comprising a multilayer stack made of III-V materials constituting a succession of quantum barriers and wells and comprising a plurality of recombination centers distributed within said stack, characterized in that said recombination centers are iron atoms which define a single discrete recombination energy level located approximately in the middle of the band gap.

2. The saturable absorbent structure as claimed in claim 1, characterized in that the recombination centers are distributed with a concentration of between 10¹⁶ cm³ and 10¹⁰ cm³.

3. The saturable absorbent structure as claimed in either of the preceding claims, characterized in that the stack comprises an In_{0.53}Ga_{0.47}As/InP succession.

4. A saturable absorbent structure made of III-V material(s) comprising a plurality of recombination centers distributed within said structure, characterized in that said recombination centers are iron atoms which define a single discrete recombination energy level located approximately in the middle of the band gap.

5. A process for obtaining a saturable absorbent multiple quantum well structure as claimed in one of claims 1 to 3, characterized in that the layers of the stack are grown by epitaxy and in that the recombination centers are introduced by doping during the epitaxial growth of said layers of the stack.

6. An optical component, characterized in that it has a saturable absorbent structure as claimed in one of claims 1 to 4.

7. The optical signal regeneration optical component, characterized in that it consists of a component as claimed in claim 6.

8. A fiber-optic transmission system comprising a transmission line and means for emitting and for receiving an optical signal transmitted by said line, characterized in that it includes, in the transmission line, at least one regeneration optical component as claimed in claim 6.
